(19) United States
(12) Patent Application Publication
(10) Pub. No.: US 2023/0262824 A1
(43) Pub. Date: Aug. 17, 2023

(54) METHODS AND APPARATUS TO SPEED UP DIRECT ACELL ACTIVATION

(71) Applicant: MediaTek INC., Hsin-Chu (TW)

(72) Inventors: Din-Hwa Huang, Hsin-Chu (TW); Chun-Fan Tsai, Hsin-Chu (TW); Tsang-Wei Yu, Hsin-Chu (TW); Hsuan-Li Lin, Hsin-Chu (TW)

(21) Appl. No.: 18/135,725

(22) Filed: Apr. 17, 2023

Related U.S. Application Data
(63) Continuation of application No. PCT/CN2021/125757, filed on Oct. 22, 2021.
(60) Provisional application No. 63/094,922, filed on Oct. 22, 2020.

(51) Int. Cl. H04W 76/20; H04L 5/00

(52) U.S. Cl. CPC H04W 76/20; H04L 5/0051; H04W 80/02

(57) ABSTRACT

A method for expediting Secondary Cell (SCell) activation is proposed. Under the proposed enhanced direct SCell activation procedure, while adding an SCell to be activated state, the network can add transmission configuration indication (TCI) state information for the SCell in a radio resource control (RRC) signaling message, in addition to TCI state information for a list of candidate TCI states. Upon receiving the RRC signaling message, UE adds the SCell accordingly, and then activates the SCell based on the received TCI state information. Because there is no additional time required for receiving and processing the TCI state information via a media access control (MAC) control element (CE), the SCell activation time is reduced.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/125757, with an international filing date of Oct. 22, 2021, which in turn claims priority from U.S. Provisional Application No. 63/094,922, entitled “Methods and Apparatus to Speed up direct SCell Activation”, filed on Oct. 22, 2020. This application is a continuation of International Application No. PCT/CN2021/125757, which claims priority from U.S. provisional applications 63/094,922. International Application No. PCT/CN2021/125757 is pending as of the filing date of this application, and the United States is a designated state in International Application No. PCT/CN2021/125757. The disclosure of each of the foregoing documents is incorporated herein by reference.

### TECHNICAL FIELD

The disclosed embodiments relate generally to wireless communication, and, more particularly, to a method for expediting Secondary Cell (SCell) activation in 5G New Radio (NR).

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board, has decided to focus the future NGMN activities on defining the end-to-end requirements for 5G new radio (NR) systems.

In 4G/LTE, a feature called “Carrier Aggregation (CA)” is supported to allow communications between a UE and a base station on multiple aggregated carriers or cells (e.g., a Primary Cell (PCell) and one or more Secondary Cells (SCells)). The design of SCell is to provide more data bandwidth in other carrier frequencies, typically higher frequencies, for boosting up data throughput while the PCell is more for ensuring the coverage. In CA, a UE is connected to one Primary cell (PCell) and one or more secondary cell (SCell). In 5G/NR, the CA feature is also employed. In legacy design, the SCell could be added by radio resource control (RRC) reconfiguration. The SCell could only be in deactivated state while adding by RRC. After a SCell is added, the SCell could be activated or deactivate by MAC Control Elements (CEs). In LTE R15 and NR R16, to speed up the SCell activation procedure, direct SCell activation is introduced so that the SCell could be activated by RRC directly (while adding the SCell). The MAC CE for activation is not necessary in some cases such that SCell activation time is reduced.

Frequency bands for 5G NR are being separated into two different frequency ranges. Frequency Range 1 (FR1) includes sub-6 GHz frequency bands, some of which are bands traditionally used by previous standards, but has been extended to cover potential new spectrum offerings from 410 MHz to 7125 MHz. Frequency Range 2 (FR2) includes frequency bands from 24.25 GHz to 52.6 GHz. Bands in FR2 in this millimeter wave range have shorter range but higher available bandwidth than bands in FR1. For NR FR2 SCell, in order to correctly sending the CSI reporting, the UE need to know the TCI state. TCI state information contains the beam information for FR2 cells. Therefore, for the cases that TCI state is needed (e.g., in FR2) and has not been configured by the network, there is no obvious benefit on speeding up the overall SCell activation due to TCI indication in MAC. MAC CE is still required to provide the TCI state and this result in additional delay. As a result, the activation time of FR2 SCell is not reduced by direct SCell activation.

A solution is sought.

### SUMMARY

A method for expediting Secondary Cell (SCell) activation is proposed. Under the proposed enhanced direct SCell activation procedure, while adding an SCell to be activated state, the network can add transmission configuration indication (TCI) state information for the SCell in a radio resource control (RRC) signaling message, in addition to TCI state information for a list of candidate TCI states. Upon receiving the RRC signaling message, UE adds the SCell accordingly, and then activates the SCell based on the received TCI state information. Because there is no additional time required for receiving and processing the TCI state information via a media access control (MAC) control element (CE), the SCell activation time is reduced.

In one embodiment, a UE enters a radio resource control (RRC) connected mode in a primary cell of a mobile communication network. The UE receives an RRC configuration from the network. The RRC configuration comprises information for adding a Secondary Cell (SCell), information for activating the SCell, and a transmission configuration indictor (TCI) indication for the SCell. The UE activates the SCell with a corresponding TCI state indicated by the TCI indication. An activation time for the SCell is reduced by a time delay from a MAC CE operation. The UE performs channel state information reference signal (CSI-RS) measurements and reporting for the activated SCell.

In another embodiment, a gNB establishes a connection with a User Equipment (UE) in a primary cell of a mobile communication network. The UE is in a radio resource control (RRC) connected mode. The gNB transmits an RRC configuration from the base station. The RRC configuration comprises information for adding a Secondary Cell (SCell), information for activating the SCell, and a transmission configuration indictor (TCI) indication for the SCell. The SCell is activated with a corresponding TCI state indicated by the TCI indication, and an activation time for the SCell is reduced by a time delay from a MAC CE operation. The gNB receives channel state information reference signal (CSI-RS) measurement results for the activated SCell from the UE.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G New Radio (NR) network supporting enhanced direct secondary cell (SCell) activation in accordance with aspects of the current invention.

FIG. 2 illustrates simplified block diagrams of wireless devices, e.g., a UE and a gNB in accordance with embodiments of the current invention.

FIG. 3 illustrates a flow chart of an enhanced direct secondary cell activation procedure in accordance with embodiments of the current invention.

FIG. 4 illustrates TCI procedure and SCell activation time under normal SCell activation, direct SCell activation, and proposed enhanced direct SCell activation.

FIG. 5 illustrates one embodiment of UE's operation in NR SCell activation and SCell activation time in Frequency Range 2 (FR2).

FIG. 5 illustrates another embodiment of UE's operation in NR SCell activation and SCell activation time in Frequency Range 2 (FR2).

FIG. 7 illustrates a flow chart of a method for expediting SCell activation from the perspective of a UE in accordance with one novel aspect.

FIG. 8 illustrates a flow chart of a method for expediting SCell activation from the perspective of a BS in accordance with one novel aspect.

### DETAILED DESCRIPTION

Reference will now be made in detail to some embodiments of the invention, examples of which are illustrated in the accompanying drawings.

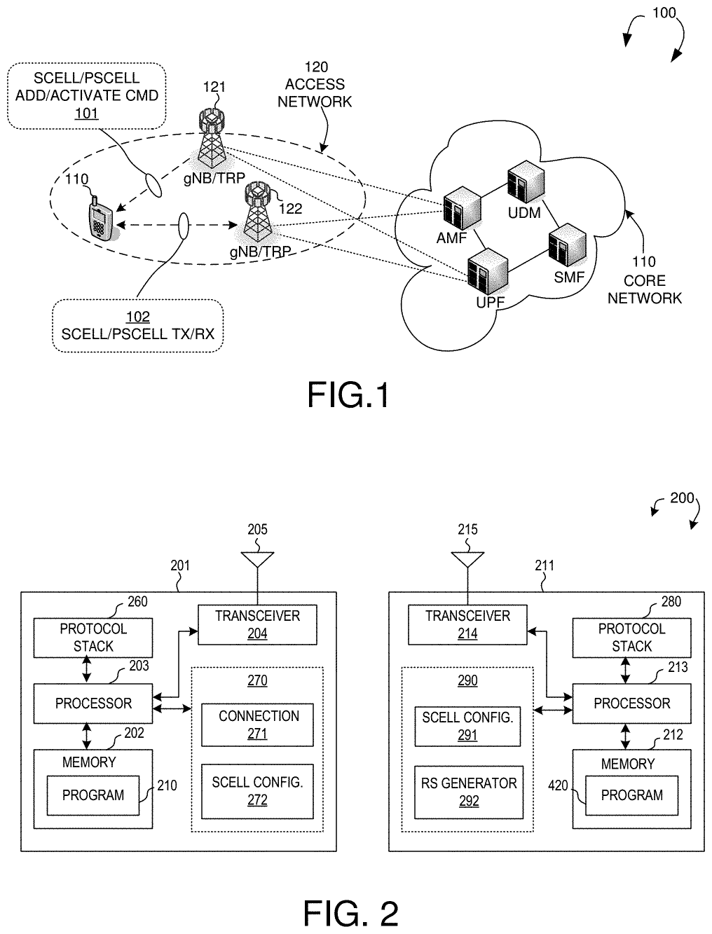

FIG. 1 illustrates an exemplary 5G New Radio (NR) network 100 supporting enhanced secondary cell (SCell) activation in accordance with aspects of the current invention. The 5G NR network 100 comprises a User Equipment (UE) 110 communicatively connected to a Base Station (BS/gNB) or transmission point (TRP) (e.g., gNB/TRP 121) of an access network 120 which provides radio access using a Radio Access Technology (RAT) (e.g., the 5G NR technology). The access network 120 is connected to a 5G core network 110 by means of the NG interface, more specifically to a User Plane Function (UPF) by means of the NG user-plane part (NG-u), and to a Mobility Management Function (AMF) by means of the NG control-plane part (NG-c). One gNB can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The gNB/TRP 121 may provide communication coverage for a geographic coverage area in which communications with the UE 110 is supported via a communication link 101. In one embodiment, the gNB/TRP 121 may be configured as a Master Node for serving the UE 110, and the communication link 101 between the gNB/TRP 121 and the UE 110 may utilize one or more frequency carriers to form one or more cells (e.g., a PCell and one or more SCells). The communication link 101 shown in the 5G NR network 100 may include transmission of control-plane data, such as an SCell/PSCell addition and activation command, and Reference Signals (RSs), from the gNB/TRP 121 to the UE 110 (e.g., on the Physical Downlink Control Channel (PDCCH) or Physical Downlink Shared Channel (PDSCH)).

The gNB/TRP 122 may provide communication coverage for a geographic coverage area in which communications with the UE 110 is supported via a communication link 102. In one embodiment, the gNB/TRP 122 may be configured as a Secondary Node for serving the UE 110, and the communication link 102 between the gNB/TRP 122 and the UE 110 may utilize one or more frequency carriers to form one or more cells (e.g., a PSCell and one or more SCells). The communication link 102 shown in the 5G NR network 100 may include uplink transmission from the UE 110 to the gNB/TRP 122 (e.g., on the Physical Uplink Control Channel (PUCCH) or Physical Uplink Shared Channel (PUSCH)) or downlink transmissions from the gNB 122 to the UE 110 (e.g., on the PDCCH or PDSCH).

In LTE R15 and NR R16, to speed up the secondary cell (SCell) activation procedure, direct SCell activation is introduced so that the SCell could be activated by radio resource control (RRC) directly (while adding the SCell). The Media Access Control (MAC) CE for activation is not necessary in some cases such that SCell activation time is reduced. For NR FR2 SCell, in order to correctly sending Channel State Information (CSI) reporting, the UE need to know the Transmission Configuration Indicator (TCI) state. A TCI state includes configurations such as Quasi-co-location (QCL) relationships between the DL RSs in one CSI-RS set and the PDSCH DMRS ports. For example, TCI state information contains the QCL relationship between CSI-RS beam and synchronization signaling block (SSB) beam in FR2 cells. Under direct SCell activation, an RRC signaling message provides TCI state information (e.g., tci-StatesToAddModList), while a MAC CE is still required to provide a TCI state indication for the SCell. Therefore, for the cases that TCI state is needed and has not been configured by the network, there is no obvious benefit on speeding up the overall SCell activation due to the TCI indication in MAC. MAC CE is still required to provide the TCI state and this result in additional delay. As a result, the activation time of FR2 SCell is not reduced by direct SCell activation.

In accordance with one novel aspect, a method for expediting SCell activation is proposed. Under the enhanced direct SCell activation procedure, while adding an SCell to be activated state, the network provides a TCI state indication in the same RRC signaling message, in addition to TCI state information for a list of candidate TCI states. Upon receiving the RRC signaling message, UE adds the SCell accordingly, and then activates the SCell based on the received TCI state indication. Because there is no additional time required for receiving and processing the TCI state indication via a MAC CE, the SCell activation time is reduced.

FIG. 2 illustrates simplified block diagrams of wireless devices, e.g., a UE 201 and a gNB 211 in accordance with embodiments of the current invention in 5G NR network 200. The gNB 211 has an antenna 215, which transmits and receives radio signals. An RF transceiver module 214, coupled with the antenna 215, receives RF signals from the antenna 215, converts them to baseband signals and sends them to the processor 213. The RF transceiver 214 also converts received baseband signals from the processor 213, converts them to RF signals, and sends out to the antenna 215. The processor 213 processes the received baseband signals and invokes different functional modules to perform features in the gNB 211. The memory 212 stores program instructions and data 220 to control the operations of the gNB 211. In the example of FIG. 2, the gNB 211 also includes a protocol stack 280 and a set of control function modules and circuits 290. The protocol stack 280 may include a Non-Access-Stratum (NAS) layer to communicate with an AMF/SMF/MME entity connecting to the core network, a Radio Resource Control (RRC) layer for high layer configuration and control, a Packet Data Convergence Protocol/Radio Link Control (PDCP/RLC) layer, a Media Access Control (MAC) layer, and a Physical (PHY) layer. In one example, the control function modules and circuits 290 include an SCell configurator circuit 291 that manages the configuration (e.g., addition/activation) of the PSCell and one or more SCells for the UE 201 by transmitting a command to indicate SCell/PSCell addition/activation.

Similarly, the UE 201 has a memory 202, a processor 203, and an RF transceiver module 204. The RF transceiver 204 is coupled with the antenna 405, receives RF signals from the antenna 205, converts them to baseband signals, and sends them to the processor 203. The RF transceiver 204 also converts received baseband signals from the processor 203, converts them to RF signals, and sends out to the antenna 205. The processor 203 processes the received baseband signals (e.g., comprising an SCell/PSCell addition/activation command) and invokes different functional modules and circuits to perform features in the UE 201. The memory 202 stores data and program instructions 210 to be executed by the processor 203 to control the operations of the UE 201. Suitable processors include, by way of example, a special purpose processor, a Digital Signal Processor (DSP), a plurality of micro-processors, one or more micro-processor associated with a DSP core, a controller, a microcontroller, Application Specific Integrated Circuits (ASICs), File Programmable Gate Array (FPGA) circuits, and other type of Integrated Circuits (ICs), and/or state machines. A processor in associated with software may be used to implement and configure features of the UE 201.

The UE 201 also includes a protocol stack 260 and a set of control function modules and circuits 270. The protocol stack 260 may include a NAS layer to communicate with an AMF/SMF/MME entity connecting to the core network, an RRC layer for high layer configuration and control, a PDCP/RLC layer, a MAC layer, and a PHY layer. The Control function modules and circuits 270 may be implemented and configured by software, firmware, hardware, and/or combination thereof. The control function modules and circuits 270, when executed by the processor 203 via program instructions contained in the memory 202, interwork with each other to allow the UE 201 to perform embodiments and functional tasks and features in the network. In one example, the control function modules and circuits 270 include a connection handling circuit 271 that establishes and manages connection, and an SCell configuration circuit 272 that adds and activates the SCell/PSCell according to the TCI information provided in the SCell/PSCell command via RRC signaling.

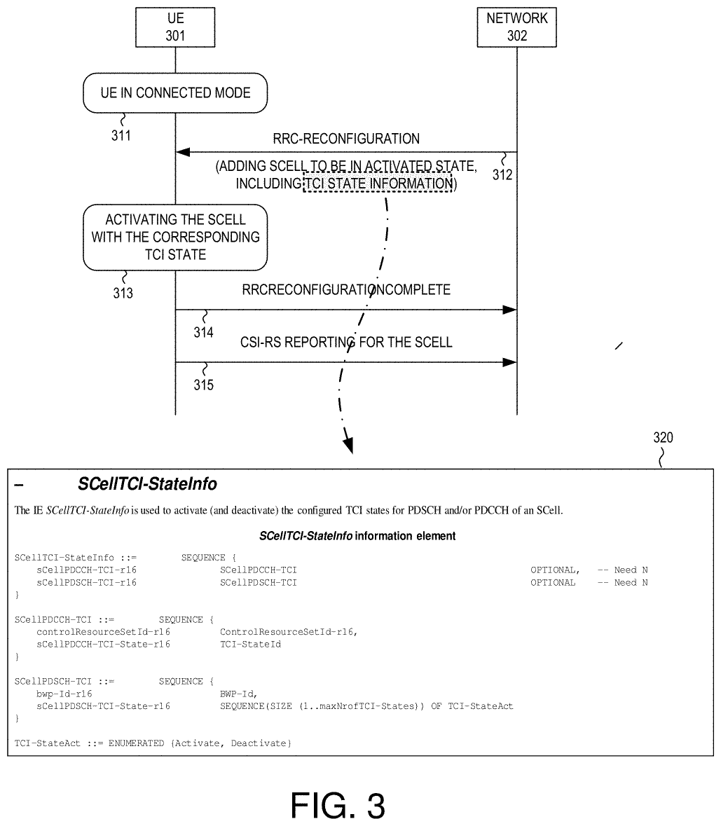

FIG. 3 illustrates a sequence flow chart of an enhanced secondary cell activation procedure in accordance with embodiments of the current invention. In step 311, UE 301 establishes a connection with network 302 and enters RRC connected mode in a primary cell (PCell). In step 312, UE 301 receives an RRC signaling (e.g., RRCReconfiguration) with RRC configuration information from network 302. The RRC configuration is for adding and activating one or more secondary cells (SCells). The RRC configuration information comprises information for SCell addition, SCell activation, and TCI indication. The SCell addition information comprises SCell index, SCell state, and SCell measurement configuration; the SCell activation information comprises candidate TCI state information, which comprises a list of candidate TCI states to be used for measurement and CSI reporting; and TCI state information comprises a TCI indication that indicates a selected TCI to be used for measurement and CSI reporting upon activation. In step 313, UE 301 activates the SCell with corresponding TCI state information. In step 314, UE 301 sends an RRC configuration complete message to network 302. In step 315, UE 301 performs measurements and sends CSI reporting for the SCell. In one example, the UE uses a beam indicated by the selected TCI state for CSI-RS measurements and reporting.

The TCI state information for SCell is also depicted by 320 of FIG. 3. SCellTCI-StateInfo comprises TCI state information for control channel PDCCH and TCI state information for data channel PDSCH. In one embodiment, the RRC Reconfiguration message includes the TCI state information of the SCell to be activated. In one embodiment, the TCI state information includes the TCI state indication for the control channel (PDCCH) of the activated SCell, comprising a CORESET Id and an activated TCI state. In another embodiment, the TCI state information includes the TCI state indication for the data channel (PDSCH) of the activated SCell, comprising of a BWP Id and a list of activated TCI states.

In NR, for the cases that TCI state is needed and has not been configured by Network, direct SCell activation at SCell addition/RRC resume:

Ndirect=T_{RRC_process}+T1+T_{HARQ}+T_{activation_time}+T_{CSI_Reporting}

### Where

T_{RRC_Process}: RRC procedure delay
T1: Delay from slot n+T_{RRC_Process} until the transmission of RRCConnectionReconfigurationComplete message

Under enhanced direct SCell Activation procedure, because MAC CE is no longer required for TCI state information for the SCell, the overall SCell activation time is reduced by T_{HARQ}+3 ms.

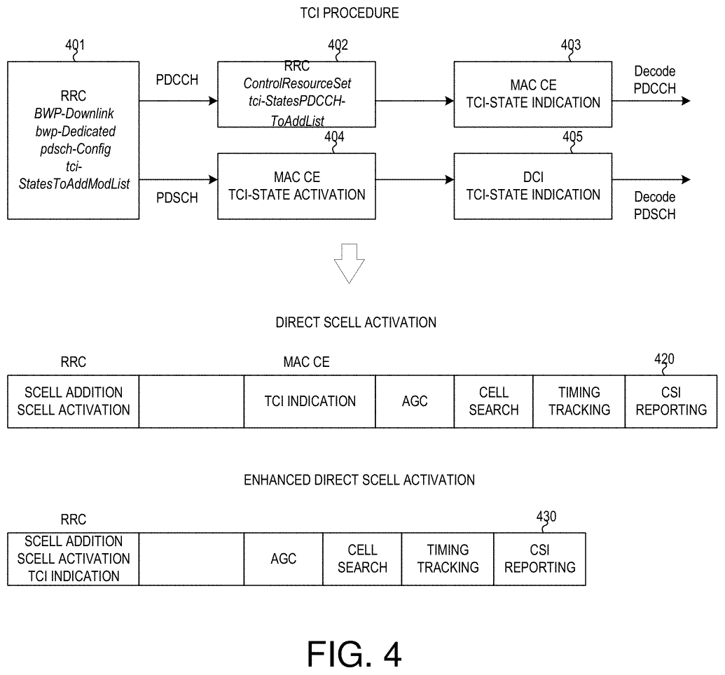

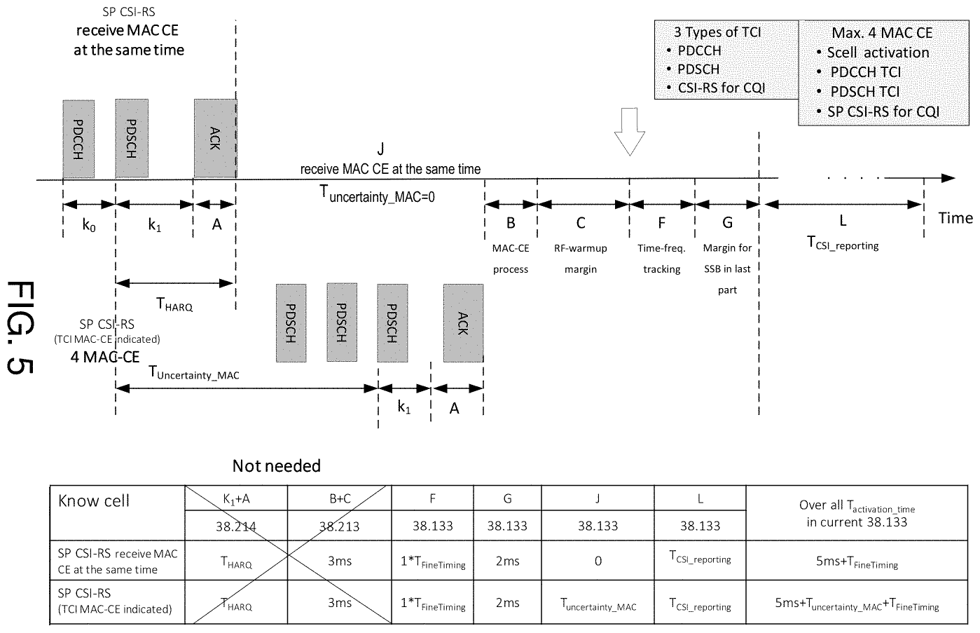

FIG. 4 illustrates TCI procedure and SCell activation time under normal SCell activation, direct SCell activation, and proposed enhanced direct SCell activation. Under TCI procedure, UE first receives RRC configuration for SCell addition (401). For example, the RRC configuration comprises BWP-Downlink, bwp-Dedicated, PDSCH-config, and tci-StatesToAddModList. For example, the tci-StatesToAddModList may comprise 256 or 128 candidate TCI-stateId. Next, UE receives RRC configuration for SCell activation (402, for control channel), and MAC CE for SCell activation (404, for data channel). For example, the MAC CE comprises TCI-state activation, which may comprise a subset of 8 TCI-stateId from the list of candidate TCIs. The actual TCI state indication may be carried by MAC CE (403, for control channel), or carried by DCI (405, for data channel).

Direct SCell activation is depicted by 420. First, UE receives RRC configuration for SCell addition as well as SCell activation. Next, UE receives MAC CE indication for SCell activation and TCI indication. After AGC, cell searching, timing tracking, UE is able to perform measurements over the SCell and reporting CSI to the network for the SCell. Enhanced direct SCell activation is depicted by 430. First, UE receives RRC configuration for SCell addition as well as SCell activation and TCI indication. After AGC, cell searching, timing tracking, UE is able to perform measurements over the SCell and reporting CSI to the network for the SCell. Note that under direct SCell activation, MAC CE for SCell activation or TCI indication is still required, especially for the cases that TCI state is needed and has not been configured by the network (in FR2). However, under enhanced directed SCell activation, MAC CE for SCell activation and TCI indication is no longer needed, because it is already included in the RRC signaling in the same time slot. UE can activate the SCell and TCI state based on the received TCI state information carried by RRC message. As a result, the SCell activation time is reduced under enhanced direct SCell activation. To summarize, under direct SCell Activation procedure, the total time from receiving the RRCReconfiguration signaling to CSI reporting is: T_{RRC_Process}+T1+T_{HARQ}+T_{activation_time}+T_{CSI_Reporting}. Under enhanced direct SCell Activation procedure, the overall activation time is reduced by T_{HARQ}+3 ms.

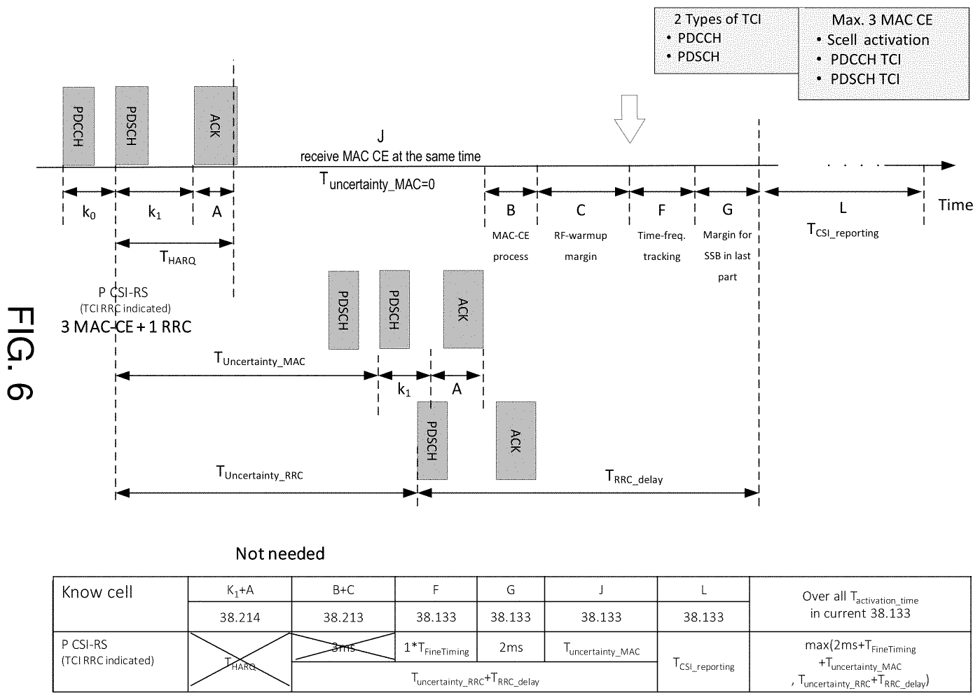

FIG. 5 illustrates one embodiment of UE's operation in NR SCell activation and SCell activation time in Frequency Range 2 (FR2). It should be understood that the timeline with respect to FR2 in FIG. 5 is for illustrative purposes only and is not intended to limit the scope of the invention. For example, the current invention may also be applied in FR1. Under enhanced Direct SCell Activation, if UE receives TCI state activation command in the same RRC signalling, and if the target SCell is known to UE and semi-persistent CSI-RS is used for CSI reporting, then the total time from the RRCReconfiguration signaling to CSI reporting is: T_{RRC_Process}+T1+T_{activation_time}−3 ms+T_{CSI_Reporting}. As depicted by FIG. 5, the overall activation time for the SCell is reduced by T_{HARQ}+3 ms(B+C).

FIG. 6 illustrates another embodiment of UE's operation in NR SCell activation and SCell activation time in Frequency Range 2 (FR2). It should be understood that the timeline with respect to FR2 in FIG. 6 is for illustrative purposes only and is not intended to limit the scope of the invention. For example, the current invention may also be applied in FR1. Under enhanced Direct SCell Activation, if UE receives TCI state activation command in the same RRC signalling, and if the target SCell is known to UE and periodic CSI-RS is used for CSI reporting, then the total time from the RRCReconfiguration signaling to CSI reporting is: T_{RRC_Process}+T1+max (2 ms+T_{FineTiming}+T_{uncertainty_MAC}, T_{uncertainty_RRC}+T_{RRC_delay})+T_{CSI_Reporting}. As depicted by FIG. 6, the overall activation time for the SCell is reduced by T_{HARQ}+3 ms (B+C).

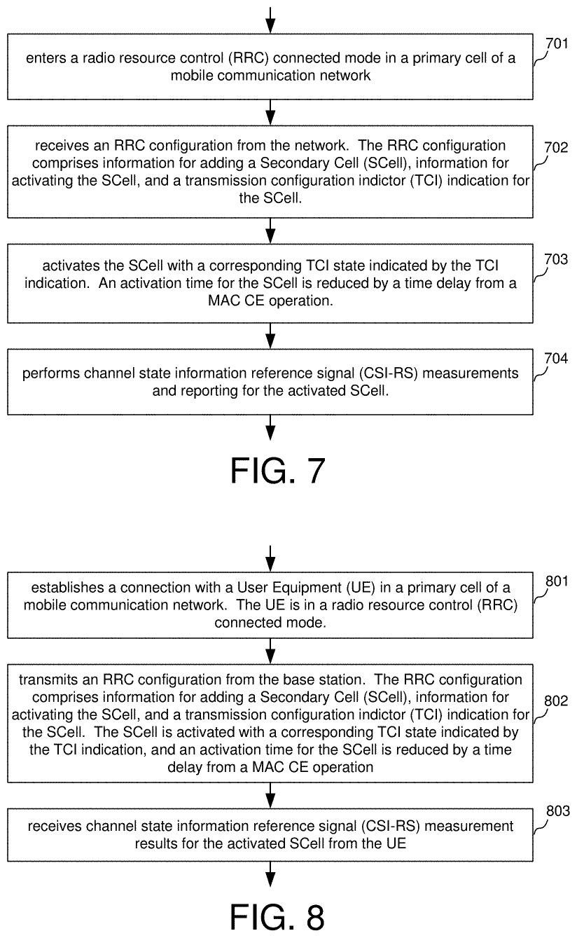

FIG. 7 illustrates a flow chart of a method for expediting SCell activation from the perspective of a UE in accordance with one novel aspect. In step 701, a UE enters a radio resource control (RRC) connected mode in a primary cell of a mobile communication network. In step 702, the UE receives an RRC configuration from the network. The RRC configuration comprises information for adding a Secondary Cell (SCell), information for activating the SCell, and a transmission configuration indictor (TCI) indication for the SCell. In step 703, the UE activates the SCell with a corresponding TCI state indicated by the TCI indication. An activation time for the SCell is reduced by a time delay from a MAC CE operation. In step 704, the UE performs channel state information reference signal (CSI-RS) measurements and reporting for the activated SCell.

FIG. 8 illustrates a flow chart of a method for expediting SCell activation from the perspective of a BS in accordance with one novel aspect. In step 801, a gNB establishes a connection with a User Equipment (UE) in a primary cell of a mobile communication network. The UE is in a radio resource control (RRC) connected mode. In step 802, the gNB transmits an RRC configuration from the base station. The RRC configuration comprises information for adding a Secondary Cell (SCell), information for activating the SCell, and a transmission configuration indictor (TCI) indication for the SCell. The SCell is activated with a corresponding TCI state indicated by the TCI indication, and an activation time for the SCell is reduced by a time delay from a MAC CE operation. In step 803, the gNB receives channel state information reference signal (CSI-RS) measurement results for the activated SCell from the UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
entering a radio resource control (RRC) connected mode by a User Equipment (UE) in a primary cell of a mobile communication network;
receiving an RRC configuration from the network, wherein the RRC configuration comprises information for adding a Secondary Cell (SCell), information for activating the SCell, and a transmission configuration indictor (TCI) indication for the SCell;
activating the SCell with a corresponding TCI state indicated by the TCI indication, wherein an activation time for the SCell is reduced by a time delay from a MAC CE operation; and
performing channel state information reference signal (CSI-RS) measurements and reporting for the activated SCell.

2. The method of claim 1, wherein the time delay from the MAC CE operation comprises a time for performing Hybrid Automatic repeat request (HARQ) T_{HARQ} plus a time for processing the MAC CE.

3. The method of claim 1, wherein the information for adding the SCell comprises bandwidth part (BWP) configuration information, data channel configuration information, and a list of candidate TCI states for the SCell addition.

4. The method of claim 1, wherein the information for activating the SCell comprises a subset of candidate TCI states for the SCell activation.

5. The method of claim 1, wherein the TCI indication comprises a control resource set (CORESET) ID and an activated TCI state for a control channel.

6. The method of claim 1, wherein the TCI indication comprises a bandwidth part (BWP) ID a list of activated TCI states for a data channel.

7. The method of claim 1, wherein the UE operates under a frequency range 2 (FR2), and wherein a TCI state is not provided by the network prior to the RRC configuration.

8. A User Equipment (UE), comprising:
a connection handling circuit that establishes a connection and enters an RRC connected mode in a primary cell of a mobile communication network;
a receiver that receives an RRC configuration from the network, wherein the RRC configuration comprises information for adding a Secondary Cell (SCell), information for activating the SCell, and a transmission configuration indictor (TCI) indication for the SCell;
an SCell handling circuit that activates the SCell with a corresponding TCI state indicated by the TCI indication, wherein an activation time for the SCell is reduced by a time delay from a MAC CE operation; and
a transmitter that transmits channel state information reference signal (CSI-RS) measurement results for the activated SCell.

9. The UE of claim 8, wherein the time delay from the MAC CE operation comprises a time for performing Hybrid Automatic repeat request (HARQ) T_{HARQ} plus a time for processing the MAC CE.

10. The UE of claim 8, wherein the information for adding the SCell comprises bandwidth part (BWP) configuration information, data channel configuration information, and a list of candidate TCI states for the SCell addition.

11. The UE of claim 8, wherein the information for activating the SCell comprises a subset of candidate TCI states for the SCell activation.

12. The UE of claim 8, wherein the TCI indication comprises a control resource set (CORESET) ID and an activated TCI state for a control channel.

13. The UE of claim 8, wherein the TCI indication comprises a bandwidth part (BWP) ID a list of activated TCI states for a data channel.

14. The UE of claim 8, wherein the UE operates under a frequency range 2 (FR2), and wherein a TCI state is not provided by the network prior to the RRC configuration.

15. A method, comprising:
establishing a connection with a User Equipment (UE) in a primary cell of a mobile communication network, wherein the UE is in a radio resource control (RRC) connected mode;
transmitting an RRC configuration from the base station, wherein the RRC configuration comprises information for adding a Secondary Cell (SCell), information for activating the SCell, and a transmission configuration indictor (TCI) indication for the SCell, wherein the SCell is activated with a corresponding TCI state indicated by the TCI indication, wherein an activation time for the SCell is reduced by a time delay from a MAC CE operation; and
receiving channel state information reference signal (CSI-RS) measurement results for the activated SCell from the UE.

16. The method of claim 15, wherein the time delay from the MAC CE operation comprises a time for performing Hybrid Automatic repeat request (HARQ) T_{HARQ} plus a time for processing the MAC CE.

17. The method of claim 15, wherein the information for adding the SCell comprises bandwidth part (BWP) configuration information, data channel configuration information, and a list of candidate TCI states for the SCell addition.

18. The method of claim 15, wherein the information for activating the SCell comprises a subset of candidate TCI states for the SCell activation.

19. The method of claim 15, wherein the TCI indication comprises a control resource set (CORESET) ID and an activated TCI state for a control channel.

20. The method of claim 15, wherein the TCI indication comprises a bandwidth part (BWP) ID a list of activated TCI states for a data channel.
